(19) United States
(12) Patent Application Publication
(10) Pub. No.: US 2001/0032522 A1
(43) Pub. Date: Oct. 25, 2001

(54) Vectored inertia drive wobble drive

(76) Inventor: Ulysses Davis JR., Cambria Hgts., NY (US)

Correspondence Address: Ulysses Davis JR., 115-100 228 ST., Cambria Hgts., NY, 11411-1418, US

(21) Appl. No.: 09/765,447

(22) Filed: Jan. 22, 2001

Related U.S. Application Data
(60) Provisional application No. 60/177,688, filed on Jan. 24, 2000.

(51) Int. Cl. F16H 27/04

(52) U.S. Cl. 74/84 S

(57) ABSTRACT

The Vectored Inertia Drive is a thrust producing apparatus optimally comprising multiple gyroscopic masses mounted to a rotating structure, wherein the spin axis of the gyroscopic masses is maintained perpendicular to the spin axis of the rotatable structure, and which are able to exhibit gyroscopic resistance and extinguish said resistance as needed. In operation during predetermined degrees the gyroscopic masses exhibit gyroscopic resistance to the rotation of the rotatable structure causing the rotational center of the entire system to move toward the gyroscopic mass imparting a motion with two linear components. By changing the rotational center in a continuous series, the device is able to impart linear motion to an attached vehicle. Because the inertia imparted actually comes from the inertia present in the gyroscopic mass and is transferred from one dimension to another, the inertial force, which is the resultant of acceleration, is vectored at 90 degrees thus the resultant of the drive is acceleration without the need for an expelled mass at 180 degrees. The drive has its greatest utility in aerospace applications.

### CROSS-REFERENCE TO RELATED APPLICATIONS

Vectored Inertia Drive/Wobble Drive—Ulysses Davis Jr.

Application Ser. No. 60/177,688

Granted: Jan. 24, 2000

The reference above is the provisional application of the present invention.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to an apparatus for creating a uniform accelerative force in a predetermined direction by converting inertial forces into acceleration. It has particular utility in the propulsion of space vehicles.

Various designs have been proposed for obtaining linear propulsion from a self-contained drive unit that does not rely on gravity, atmospheric effects, magnetism or any other external action/reaction effects. Most designs employ mechanisms that vary the location of masses from a center of rotation. These devices usually use rotary movements where the reciprocating thrust producing mass has a greater effect in a portion of the cycle and significantly less effect in the remaining portion of the operative cycle, causing thrust impulses making their operation jerky. Being primarily mass reaction machines, scaling the output thrust of these devices is limited not only by materials which must contend with the sudden intense forces produced by large masses, but also by the inability of vehicles and payloads to survive sudden jarring motions. Due to the need for large relative masses in these types of devices, they are of limited use in aerospace vehicles. These devices are also limited in their efficiency due to the need to retract and restrain the effector masses at particular points in the rotary cycle.

The present invention is an apparatus that uses an arrangement of gyroscopes in a manner that produces linear acceleration that does not rely on a linear mass action-reaction, because of this fact the invention is capable of delivering a vectored thrust without the displacing of matter in the opposite direction. All embodiments of this invention are able to produce strait-line acceleration in any single direction parallel to its main rotational plane without the need to point or reorient the drive itself, embodiments one, two and five are capable of nearly instant directional changes. The design is able to produce self-supporting lift with respect to its own frame of reference. The present invention appears to violate Newton's third law of motion with respect to the vectored nature of linear inertial exchanges. It will be shown below with reference to FIGS. 1-9, that gyroscopic resistance is actually the result of a non-linear inertial/momentum exchange, and that gyroscopic resistance to rotation about its spin axis is evidence of a right angle, 90 degree, vectored inertial exchange as opposed to the opposite, 180 degree vectored inertial exchange described by Newton's Third Law. It will further be shown that this invention uses this unique characteristic of gyroscopic masses to convert a tendency to resist a change in speed (inertia) into a tendency to change speed (acceleration). Thus it will be shown that the present invention adheres to Newton's Third Law as it relates to the behavior of rotating masses and that the claim of inertial conversion is valid.

To understand the concepts behind this invention, consider first the primary behavior of spinning masses (henceforth called gyros), which is to resist any attempt to change the direction of the axis about which the mass spins. Another important issue is the behavior of rotating bodies and the relation to its center of rotation and how a balanced rotating body can be made to wobble without adding to or changing the distribution of the mass of the object. The final and most important concept is that even though ours is a three dimensional universe, linear motion is actually always one dimensional. The result of this one dimensional nature is what is actually being described by Newton's Third Law. Additionally that it is possible to produce two dimensional motion and induce inertial transfers across the two axis, so that linear motion is achieved without linear inertial exchange.

The ability of gyros to resist directional change in their axis is so well demonstrated by various devices that no further elaboration is necessary other than to point out that the extremely strong resistive forces that can be developed in gyros is primarily dependent on the distribution of the mass in the gyro and the amount of energy used to spin the gyro, and not on the mass of the gyro itself. In addition, as the amount of power applied against this resistive force is increased, in this case increasing the speed of the attempted reorientation, the resistance itself increases. This is evidenced by the fact that a less massive gyro spun at a high speed can produce equal or greater amounts of gyroscopic resistance than a more massive gyro with a low rotational speed. Similarly if two rotors have the same mass but one has more of that mass arranged in a ring farther from its center, it will produce many times the gyroscopic resistance at a given speed than the gyro whose mass is close to the rotational center. The last point regarding increases in gyroscopic resistance relative to the power used to reorient it, is easily apparent by spinning a gyro and attempting to reorient its rotational axis. A mild resistive force is apparent if the rate of the reorientation is low. However, as one attempts to increase the rate of change in the gyro's axis, the resistive forces increase in turn. This increased resistance does not come freely, as the gyro's rotational speed decreases faster as more of its rotational inertia is used.

Balanced powered rotating objects spin evenly around their axis of rotation, otherwise known as their centers. This is because in a balanced powered rotating object the axis of rotation (or torque axis), the center of gravity/center of rotation are located at the same point on the object, the center. Unbalanced objects wobble because the center of gravity/center of rotation is located away from the object's torque axis. FIG. 6 of the attached drawing sheets makes this point clear. PV1 shows a powered hub with two opposing strait vanes, PV2 shows a powered hub with two opposing vanes set to different angles of attack in relation to the direction of rotation of the hub. Ignoring any counter-rotation effects produced by the motors and assuming the vanes on PV2 have been positioned to maintain mass equilibrium between both halves of the hub, it is easy to see that if placed in a sufficiently viscous medium (water for instance) that while PV1 would rotate evenly around its torque axis, PV2 would generally follow the indicated wobble orbit. This wobble is not caused by a difference in weight distribution but rather the unbalanced distribution of resistance caused by the one vane that presents a high angle of attack in the direction of its rotation on the viscous medium.

The fact that all linear motion is one dimensional or in one direction only, is not readily apparent. It would appear that linear motion can exist in any or all directions simultaneously. This is not the case. In FIG. 8A particle PA has a maximum speed of 2 cm./sec., when traveling in the X or Y axis (FIG. 8A Dia.A-B) PA can cover 2 cm. in one second however PA is never able to cover 2 cm. in one second in the X axis as well as the Y axis simultaneously. It would appear that this is because PA would be traveling along the hypotenuse of point 0.0 and 2.2 but this is not really the issue. If linear motion was two dimensional we would be able to accelerate PA using two thrusters, one in the X dimension and one in the Y dimension, to its maximum speed both directions, X and Y, covering the hypotenuse distance in the same one second, but we can't. It is in fact impossible to accelerate PA by any linear means that would cause PA to gain motion both the X and Y dimensions simultaneously. FIG. 8B Dia.A-B-C demonstrates this, While FIG. 8B Dia.A-B shows one dimensional input forces and their one dimensional resultant, FIG. 8B Dia.C shows how two force inputs, each in a different dimension, partially cancel to produce a combined resultant that is one dimensional. Viewed another way, part of the force input in the X axis is always felt as resistance in the Y axis and the inverse of that is also true, if both equal force inputs were applied to opposite sides of FIG. 8B Dia.C all of the opposite force would be felt as resistance with no resultant force, and thus no motion. Newton's Third Law is an expression of this one dimensional nature of linear motion. Whether by rocket, jet engine, magnetic fields, or wheels and gears, all motion is the result of inertial transfers, either a body in motion pushes on a body at rest transferring all or part of its momentum (which is caused by inertia), or like in the case of a rocket, a body at rest pushes on another body at rest converting the rest inertia into acceleration. Due to the one dimensional nature of linear motion as noted above, Newton's Third Law is certainly correct, all actions cause equal and opposite reactions. If however one were able to create an object capable of two dimensional motion, Newton's Law would not be valid for inertial interactions between dimensions. It could be possible to obtain an equal but not opposite reaction, wherein inertia in one direction is converted into acceleration in another direction. A rotating mass is capable of two dimensional motion. FIG. 7A shows a rotating mass (BG) composed of four large particles (PA,PB,PC,PD), which are representative of all the atoms comprising BG. Centrifugal force is the result of inertia, all particles of BG act as if they are traveling in a strait line and as long as BG remains together as a whole the continuous changes in particle direction are equaled by the transfer of momentum through adjacent particles to opposing particles as illustrated by the force arrows in each particle in BG. Furthermore at each moment in time every particle within its own frame of reference is traveling in a strait line in the direction of BG's rotation. Imagine for a moment that PA represents a position in BG instead of a discrete portion, every atom that passes through position PA is at that instant traveling in a strait line in the direction indicated by the arrow within PA. It is easy to see now that although BG is a rotating object the particles that comprise BG are not rotating, they are always traveling in a strait line or linear fashion as shown by the path of PA over 4 seconds in FIG. 7A. Gyroscopic resistance is actually due to an attempt to deflect the path of the particles in a rotating mass as seen in FIG. 7B. A force TF at a rate of 0.5 cm/sec is applied to change the direction of BG's spin axis. As shown by the graph of PA's path in FIG. 7B, at the instant that TF is applied, the path of PA changes. The resistance present in BG comes from the tendency of the particles that comprise BG to resist changes in the direction of momentum. Viewed another way, just as in FIG. 8B Dia.C two forces, a force causing linear motion in PA and a force at right angles to the motion of PA, converge with portions of each force being felt as a resistance to the other just as with all one dimensional linear motion. So really then the resistance felt by TF is actually then the linear momentum of PA, thus an inertial transfer has occurred that is equal, but not opposite, the transfer has been rotated 90 degrees. An additional proof of the previous statements is that no amount of force can cause a gyroscope to gain momentum in rotating perpendicular to its spin axis, that is to say to continue to rotate without a force present. BG rotates in direction TF only when a force is present, the moment the force is eliminated, the rotation stops. No degree of resistance can eliminate momentum. In direction TF, BG has no rotational inertia or momentum at all perpendicular to its spin axis, this would completely violate Newton's First Law when seen from a purely linear standpoint. If however, the concept stated above is applied it is easy to see that force TF transfers inertia/momentum to PA in the opposite direction of the rotation of BG. This is why a gyro slows down when forced to rotate at right angles to its rotational axis. This is also why no force can cause a gyro to gain momentum in rotating perpendicular to its spin axis since the gyroscopic resistance is actually the manifestation of pure inertial force only, in the same way that a magnetic force has no mass and thus no inertia but only force and direction. The inertial/momentum exchange between TF and the particles of BG does not occur in the dimension/direction of force TF but is rotated 90 degrees in the dimension of PA's rotation, where moment to moment PA is actually traveling in a strait-line linear fashion. It can be seen then that all linear motion is one dimensional or in one direction only, that the atoms comprising a rotating mass are actually moving in a linear motion moment to moment, and that gyroscopic resistance to forces that reorient a gyro's rotational axis actually come from an inertial transfer from one direction to the other, at an angle of 90 degrees. This inventor is currently unaware of any thesis, articles, or other document published by those skilled in the pertinent sciences regarding the aforementioned 90 degree inertia/momentum exchange possible in gyroscopes. However, having built a working theoretical proof as well as a prototype the inventor needed to isolate the source of the inertia transfer to fully understand why the present invention works.

All of the preceding statements and proofs were needed to show the validity of the following concepts. FIG. 9 shows a rotating mass, having established that the particles comprising a gyro are actually in linear motion moment to moment, it is easy to see that by accelerating BG in a direction parallel to the spin axis, the particles in BG gain two dimensional motion. Particle PA can now travel in the X axis and the Y axis simultaneously. What is important to understand by FIG. 9 is that although the object BG does not have two directional (dimensional) motion the particles that comprise BG do have two dimensional motion. Having established the point that though rotating, PA from moment to moment is actually traveling strait, the fact that PA is then accelerated in a direction that is at right angles, proves that PA is moving in two separate directions. Most importantly it is critical to understand that these two motions are totally independent of each other, meaning, inertia can be gained or lost in either direction without effecting the inertia/momentum in the other. A negative inertial exchange parallel to the spin axis of BG (FIG. 9) will cause BG to lose momentum in that dimension or direction, while a negative 90 degree inertial exchange in BG will cause a loss of angular momentum in BG. Therefore it could be possible to have a source of inertia in one direction that can be transferred to the other without a 180 degree exchange. So it is the behavior of the particles or atoms in BG that are the possible source of an inertial transfer that while equal does not have to be in opposite directions, but is instead at 90 degrees. This represents a slight modification of Newton's Third Law, as this inventor hopes can be readily discerned from the examples and proofs offered above. Having built and tested both a working theoretical proof, where a balanced platform was made to wobble due only to the spinning of an attached gyro and a working prototype similar in design to the first embodiment, the preceding dialogue was needed to explain how and why the invention works.

The following will describe how the present invention uses the behaviors described above. FIG. 2 shows a simplified embodiment of this invention. Two gyroscopic means are connected through a structure which has a motor (F) situated between them that rotates the entire structure in direction R. With both gyros spinning, the center of rotation remains at G the torque axis, the gyroscopic resistance present is balanced relative to G. In FIG. 3 gyro C is spinning, but gyro N is not, therefore the resistance relative to G is uneven and thus a wobble orbit is caused to occur since the center of rotation has moved to the point of resistance, which is the center of gyro C. This is exactly the same behavior described in FIG. 6 by PV2 in a viscous medium. It is not however necessary to stop a gyro to nullify its gyroscopic resistance, as demonstrated in FIG. 4 a gyro that is allowed to rotate freely presents no gyroscopic resistance at all. Thus the apparatus is made to wobble with two spinning gyros if one gyro is locked to a rotational axis at right angles to the gyro's rotational axis, and the other is free to rotate relative to said perpendicular rotational axis. It is important to note that the wobbling torque axis (G), the center of the vehicle, has components of linear motion. FIG. 3 shows the linear components of G, the horizontal component (LT) and the vertical component (LT2). These components are not equal at all points in the orbit but are equal within 360 degrees eliminating any net travel. At 0 degrees linear travel is nearly entirely vertical, at 90 degrees it is evenly vertical and horizontal, and at 180 degrees it is nearly entirely horizontal. FIG. 5 shows the simplest way to apply all of the points discussed above. The gyros on both sides of the vehicle are spinning at a rate to produce significant gyroscopic resistance (the direction of their individual spin is irrelevant), and the motor at G is engaged to rotate the vehicle in the direction of the arrow. At the start point the right side gyro is locked to G and the left is free to rotate relative to G. At 90 degrees LT2 is at its highest point but then decreases so that at 180 degrees LT2 has returned to baseline with no net travel. LT on the other hand has achieved its maximum linear travel. At this point the locked gyro is now on the right side and the free gyro is on the left, by now locking the previously free gyro and likewise unlocking the previously locked gyro, the cycle is made to repeat. By properly alternating the state of the respective gyros between locked and unlocked the vehicle is made to travel in a desired direction but in a leapfrog fashion due to the vertical component LT2. It is important to point out that there is no linear opposite reaction to the movement of G because G is actually orbiting the locked gyro. With the gyro now the center of rotation, the inertia of G and the vehicle is represented as torque forces to the gyro. The actual inertial or momentum transfer takes place at a 90 degree angle, with the particles that comprise the gyroscopic mass, thus the gyro slows as its momentum is transferred. The preferred embodiment of this invention employs an arrangement of gyros to eliminate the vertical component of the induced wobble.

FIG. 1 describes a preferred embodiment of this invention. A motor (F) is rigidly coupled to a structure (E) and a vehicle (H) so as to be able to rotate E relative to H. Rotatably mounted to E are gyro units comprised of a gyroscopic means (C), a motor (B), a means (A) of supporting and rigidly coupling C and B to the rotatable mount and a rotatable mount (D) that maintains the spin axis of C perpendicular at all times to that of structure E (G), whereas said rotatable mount is free to rotate relative to G when needed and is able to be held motionless in relation to G when needed. The final component being a means of temporarily coupling rotatable mount (D) to E and thus prevent movement of the spin axis of C relative to G, in this case this means is a solenoid (S). In operation F rotates E in direction R. Gyro units in the Null Phase are free to rotate relative to G, thus the Null Phase is non thrust producing. In other words the Null Phase is simply the arc of rotation of E where the gyro units present no gyroscopic resistance to the system. Gyro units in the Conversion Phase (CP) are coupled to E and thus held motionless relative to G by the action of S on D. More specifically mechanism S is engaged at point CP1 coupling the gyro unit to E and thus G and S is released at point CP2, allowing free rotation of the gyro unit relative to G. The effect is similar to that described in FIG. 4, the center of rotation is moved due to unbalanced resistance, causing the wobble orbit of G and the attached vehicle H in the linear direction T. The major difference being that by using multiple gyro units, this arrangement allows for the suppression of the portion of the induced wobble orbit that is perpendicular to the desired linear axis. FIG. 5 shows how this is possible. It is clear that the undesired linear component is LT2. It is also clear that LT2 starts at a baseline that is exactly in-line with G, LT2 increases to its maximum at 90 degrees and returns to the baseline at 180 degrees. FIG. 10 illustrates how the arrangement of gyro units in a preferred embodiment of the present invention produce opposing vertical forces that tend to cancel the portion of the wobble orbit that is perpendicular to the desired linear motion axis. As two gyro units are able to occupy the Conversion Phase at the same time, the vertical portion of the force produced by the right gyro (UF), is exactly countered by the vertical portion of the force produced by the left (DF), leaving only the desired linear component T. It should also be easy to see from FIG. 1, that the location the Conversion Phase (CP) relative to G, determines the direction of acceleration, and since the location of CP is determined by the degree of arc in which a solenoid (S) locks the rotational axis of C to G, we can instantly change the location of CP by changing which gyro units are being held. Therefore this preferred embodiment can instantly change the direction of acceleration to any angle in the plane of rotation of E, without changing the rotational direction of E or the gyroscopic means. Before describing “Prior Art” a summary of key points is needed. The present invention produces linear acceleration based on gyroscopic resistance which allows a 90 degree inertial exchange from the gyro's angular momentum. The mass of the gyroscopic means is not as important in producing acceleration as is the energy put into spinning the gyroscopic mass and the energy put into rotating the main structure (E) to which the gyro units are mounted. The direction of spin of the gyros is irrelevant in determining the direction of acceleration. The direction of rotation of the main structure (E) by itself does not determine the direction of acceleration, only when combined with the location of the Conversion Phase is the direction of acceleration determined. The Null Phase is the degrees of arc outside the Conversion Phase, in which nothing pertinent to the production of thrust happens. The Conversion Phase, is the degrees of arc in which the gyro units are prevented from rotating relative to G, and it is this portion of the rotary cycle that produces thrust.

Two other designs of note are described in U.S. Pat. No. 5,090,260 M. S. Delroy and U.S. Pat. No. 5,860,317—E. Laithwaite et al. The fundamental concepts and basic operation of these two devices are completely different from the present invention. Most importantly is the fact that both of these devices claim to exploit the secondary gyroscopic phenomena of precessional movement and the effect it has of rotating the gyroscopic mass in one direction without momentum or an equal opposite reaction. Therefore both prior devices are actually mass reaction machines that employ precessional gyroscopic motion to reduce the effect of the thrust producing masses during a portion of its rotary cycle. Like other mass reaction machines both of these devices produce a thrust primarily in two opposite directions with a thrust greater in one direction than the other. Thus these devices produce an inevitable rectilinear or pulsing thrust unless a plurality of said devices are combined in a way to reduce this pulsation. The present invention exploits the primary gyroscopic inertial effect of resisting reorientation of its rotational axis to initiate a wobble effect, the linear component of this wobble is extracted which is manifested as unidirectional linear acceleration with no reverse components. More specific differences between these devices and the Inertial Impulse Conversion Drive/Wobble Drive will be considered below.

FIG. 3 of U.S. Pat No. 5,090,260—M. S. Delroy illustrates a motorized gyro unit (10) attached to a shaft (14) which is coupled to an opposite shaft (15) and gyro unit (11) through gearbox (16) by a set of gears as set forth in FIG. 3A. So that torque applied to axle (17) causes the precessional rotation of the upper gyro unit(10) which causes the rotation of the lower gyro unit (11). So while the rotational axis of the gyro units intersects and is always perpendicular to the central rotation axis, the spin axis of the gyro wheel (line AB) oscillates from being fully perpendicular to fully parallel. It is assumed that this difference in positioning is one of the operating principles of the Delroy device. In contrast the Wobble drive requires that the rotational axis of its gyro units remain completely parallel with the rotational axis of the main axis. In addition it is also crucial (in all embodiments but the fifth) that the gyro units are allowed to spin freely in relation to the main axis, or otherwise eliminate any significant gyroscopic effect, during more than (>) 180 degrees (null phase) of its circular path around the main axis, and conversely held motionless in relation to the main axis during less than (<) 180 degrees (conversion phase) of its circular path around the main axis. In the Wobble Drive, the spin axis of the gyroscope (the actual spinning mass) is always perpendicular to the spin axis of the main structure to which they are mounted. Other significant differences found in Delroy's patent are summarized below:

Column 7 line 16-19 it is stated that should the direction of the gyro wheels (gyroscopic mass) be reversed the direction of the force is reversed—direction of gyro wheel spin is irrelevant to the operation of this invention, changing the direction of gyro mass spin will have no effect on direction of acceleration. Column 7 line 60-62 states that linear force is maximum at 90 degrees and minimum at 180 degrees, which indicates a rectilinear pulsing quality to the propulsion—The preferred embodiment of the present invention produces non-oscillating continuous unidirectional acceleration, and any version of the present invention using fewer than 4 gyroscopic resistance points will produce a unidirectional propulsion that has an arcing characteristic that oscillates at right angles to its line of travel, and on the side opposite the conversion phase. Column 10 line 2-4 states that varying the platform (termed gyro units above) speed in relation to the main axis causes a change in the direction of the output force - change in main axis speed in all embodiments of the present invention causes an increase or decrease in the amount of acceleration produced not direction.

U.S. Pat. No. 5,860,317—Laithwaite et al., will be considered below. While the structures and principals of the Laithwaite device described in FIGS. 3, 10, 12-17 & 18-20 relates to mass reaction machine using gyroscopic precession, which is an entirely different concept from the present invention, FIGS. 21A, 21B, 22-25 contains some concepts which would include individual rotatable gyroscopic units and allowing and preventing the rotation of said gyroscopic units relative to the main axis of a structure to which it is connected. FIGS. 21A, 21B & 22 illustrate top and side views of the fourth embodiment of the aforementioned device. It is clear in claim #1 beginning in Col. 15 line 64 that the intended method of all embodiments of the Laithwaite device is to exploit gyroscopic precession in positioning a mass (reducing its effective mass) and then translating that mass to achieve an action-reaction movement on the whole. This is further supported by claim #5 which refers to causing the gyroscope to follow a path such that motion of the gyroscope varies between a substantially entirely precessional motion (where the effective mass is reduced by said precession) and substantially entirely translational motion (where the mass is accelerated causing an opposite reaction). To achieve this precession particularly in the fourth and fifth embodiments requires that specific rotational speed relationships between the gyroscopic means, and the rotating main structure are maintained, as indicated by statements in Col. 6 line 39-43 and Col. 14 line 30-32 as well as in claim #9 in Col. 16 line 46-48, failure to maintain these relationships results in elimination of the precessional mass transfer (P in FIG. 25-28) and thus the device produces no thrust. Therefore in FIG. 21A the gyroscopic unit is clamped to T at II and rotated by M (a motor) through 180 degrees at a particular speed related to the known rotational speed of the gyroscopic means G, to produce the precessional effect needed for mass transfer (P in FIGS. 25-28), at point 2II the clamp is released and M accelerates the full mass of the gyroscopic means through the remaining 180 degrees causing an opposite thrust reaction. Additionally the Laithwaite device requires that the thrust producing phase comprises half (180 degrees) of its rotational cycle as indicated in Col. 13 line 31-34, Col. 14 line 31-38, Col. 15 line 36-41, and FIGS. 2, 3, 8, 9, 13, 15-18, 20, 21, 25-28. Put simply the gyroscopic unit is held motionless in relation to the main axis during the non-thrust producing portion of its cycle and is free spinning during the thrust producing portion of its cycle, both cycles being 180 degrees of arc.—The intended method of all embodiments of the present invention is to exploit the force of gyroscopic resistance, which is the result of a 90 degree inertia/momentum exchange, conventional 180 degree action-reaction effects do not exist. There is no specific relationship between the rotational speed of the gyroscopic means and the rotational speed of the main axis. An increase in speed to either the gyroscopic means or to the main axis results in an increased accelerative force. In FIG. 1 of the present invention, it is important to note that the gyroscopic units (B) must be held motionless in relation to the main axis (G) during the thrust producing portion of its cycle (CP), completely opposite to the prior invention mentioned above. Furthermore CP must be significantly less than 180 degrees for the first, second, third, and fourth preferred embodiments of the present invention to work, since two opposing gyroscopes whose axis of rotation is perpendicular to that of a central axis to which each is rigidly fixed, only cause gyroscopic resistance, this is illustrated in FIG. 2.

In the Laithwaite device it is also therefore clear that since the precessional movement is used to simply position the gyroscopic mass and that the thrust is actually produced by accelerating the gyroscopic mass in a given direction, the mass of the gyroscopic means is critical in determining how much thrust is produced. In the present invention the input of energy during the conversion phase is far more critical than the mass of the gyroscopic means itself. A less massive gyroscopic means maintained at a higher rotational speed than a more massive one during CP can produce equal or greater output force than the more massive gyro, because of the increased gyroscopic resistance developed. Increasing the rotational speed of the main axis (G) can also increase the output force of said less massive gyroscopic means, because gyroscopic resistance to reorientation increases as the speed of the reorientation increases. Other differences between the Laithwaite device and the present invention are summarized below:

Col. 15 line 22-41 and claims 1 and 10 makes it clear that the Laithwaite device requires the gyro masses to complete a 360 degree cycle to produce thrust, 180 degree precession dominated mass positioning portion, then a 180 degree translation dominated thrust producing portion. Thus the mass that produces the thrust must traverse through the non-thrust producing portion of the cycle or the device cannot work.—In all embodiments of the present invention the non-thrust producing portion of the cycle, called the Null Phase, no mass is required. This can be easily seen from the fourth embodiment of the present invention (FIGS. 17 and 18) where the gyroscopic mass is actively transferred out of the Null Phase at TR2 and into the Conversion Phase at TR1 continually.

Col. 6 line 35-38, 43-49, Col. 9 line 62 through Col. 10 line 21, Col. 10 line 58-63, Col. 14 line 6-9, 51-59 as well as claims 1, 2, 3, 4, indicate that in order to cancel unwanted torques four counter rotating and mirrored gyroscopic means are required. The mirroring includes rotational direction, rotational speed of the gyroscopic means as well as the main axis (T in FIG. 22). As illustrated in FIG. 22 the double sided main axis T is rotated in the same direction.—In the present invention no mirroring of any portion of the drive is needed. The second preferred embodiment of the present invention employs two rotating main structures to which the gyroscopic units are mounted and share a single main axis. The two structures rotate in opposite directions in relation to each other and are driven by a single motor, this arrangement completely eliminates all unwanted torques without the need for additional drive units.

### BRIEF SUMMARY OF THE INVENTION

The embodiment of the present invention is a completely self contained, thrust producing apparatus that uses an arrangement of powered gyroscopic units, to create a uniform propulsive force in a predetermined direction. This method of propulsion involves no thrown or accelerated masses. Unlike precession dependent inertial propulsion devices, no critical rotational speed relationships need to be maintained. By exploiting a unique property of gyroscopic masses, the present invention is able to create this propulsion without a linear inertial transfer. Therefore the drive is able to function independent of any outside force or medium. The amount of thrust produced is primarily dependent on the amount of energy supplied to the drive and thus is highly variable. The mass of the gyroscopic units is not the critical factor in producing thrust therefore high power to weight ratios are possible. This invention has primary utility in the propulsion of space vehicles, and as a means to assist lift and flight control mechanisms on conventional aircraft.

### BRIEF DESCRIPTION OF THE SEVERAL VIEWS OF THE DRAWING

FIG. 1 is a diagram of the first embodiment of the present invention mounted, on its side, to a vehicle (H). It shows the relationship between the Null Phase and the Conversion Phase and also the relationship between main structure rotation (R), Null Phase/Conversion Phase, and direction of output acceleration (T).

FIG. 2 depicts the behavior of an object with two equal, spinning gyroscopic masses rigidly fixed to a structure that incorporates a motor (F) at its center (G) which rotates the entire structure in direction R.

FIG. 3 depicts the behavior of an object with a spinning gyroscopic mass (C) and a non-spinning gyroscopic mass (N), both of which are rigidly fixed to a structure that incorporates a motor (F) at its center (G) which rotates the entire structure in direction R. It also shows the linear components of the wobble orbit caused by the uneven rotational resistance caused by C, the horizontal component (LT) and the vertical component (LT2).

FIG. 4 shows a simplified drawing of the fifth embodiment of this invention. FIG. 4 also depicts the behavior of an object with two spinning gyroscopic masses which are rotatably mounted to a structure, wherein the axis of rotation (A) of the gyroscopic mass on the left is allowed to rotate in relation to G and an identical gyroscopic mass on the right is prevented from rotating relative to G. In a structure that incorporates a motor (F) at its center (G) which rotates the entire structure in direction R. It also shows the wobble orbit caused by the uneven rotational resistance caused by the right side gyro, due to its spin axis (A) being locked to G.

FIG. 5 illustrates how the simplest embodiment of this invention is able to propel itself by alternating axis A of two gyro units between locked and free spinning states, in relation to G, while being rotated by a central motor. It further illustrates that while there is no net travel in direction LT2, there is significant linear travel in direction LT, and that this linear travel exhibits a hopping or leapfrogging behavior.

FIG. 6 shows two objects in a viscous medium spun in the direction of the arrows by a motor, and how the rotational behavior of the two otherwise identical objects are different because of rotational resistance. Due to an imbalance in rotational resistance, in PV2 the torque axis or central axis, follows a wobble orbit, while PV1 having balanced rotational resistance continues to spin evenly about its torque axis.

FIGS. 7A and 7B depicts shows the motion of the atoms in a rotating mass. FIG. 7A illustrates how the particles (atoms) in a rotating gyroscopic mass are, moment to moment, actually traveling in strait-line linear motion. FIG. 7B illustrates how the path of a particles in a rotating mass is altered from strait-line motion in one direction (FIG. 7A) to strait-line motion in an alternate direction as result of a force (TF) at right angles to its axis of rotation. It further shows that the resistance demonstrated in gyroscopes is the result of this change in direction, which is also known as inertia.

FIG. 8A diagrams A,B,C and 8B diagrams A,B,C illustrate the one dimensional nature of linear motion and linear inertial exchanges. FIG. 8A diagrams A,B,C show the one dimensional linear travel of a particle (PA) and how PA can travel in one direction or another, but is never able to travel in two dimensions simultaneously at its maximum speed. FIG. 8A diagrams A,B,C show the result of one dimensional and two dimensional force inputs and their results. It further illustrate how linear forces combine and cancel and why PA is never able to achieve two dimensional motion from any linear inertia/momentum exchange.

FIG. 9 depicts a rotating mass (BG) that is also accelerated in a direction parallel to its spin axis, in which PA serves as an example of all the particles that comprise BG. FIG. 9 further shows how PA moment to moment, is traveling in a strait line in the direction of spin of BG and simultaneously in strait line motion moment to moment in a second direction parallel to the spin axis of BG. Thus illustrating that PA now has two dimensional motion.

FIG. 10 illustrates how a plurality of gyroscopic units in the conversion phase causes canceling forces in the portion of its linear motion that is perpendicular to the desired direction of linear motion, leaving the resultant acceleration predominantly in one direction.

FIG. 11 is a three dimensional drawing of the second embodiment of the present invention which is comprised of two first embodiments (FIG. 12), each connected to opposite ends of a motor and made to counter-rotate by said motor, so as to eliminate any net torque. It also illustrates the relationship between the foreground impeller (U1), its relevant conversion phase (CP) and direction of rotation (R), the point where the gyroscopic units are coupled to the structure (CP1) and the point where the gyroscopic units are allowed to spin freely (CP2) and the second impeller (U2) its relevant conversion phase (SCP) and direction of rotation (R2), the point where its gyro units are coupled (SCP1) and free spinning (SCP2) and the resultant thrust direction (T).

FIG. 12 is a three dimensional illustration of the first embodiment of this invention mounted to a vehicle (24) via a motor (20). It shows the direction of rotation of the drive caused by 20, the beginning of the conversion phase (CP1) and end of the conversion phase (CP2), and the resultant thrust (27). It also depicts the motorgyro unit (25) which is comprised of a gyroscopic mass (15), rotated by a motor (16), rigidly fixed to and supported by a cross member (17), which itself is rigidly fixed to a structure (18) rotatably mounted to the main structure (19).

FIG. 13 is a cross section side view of the main structure (19) and the motor-gyro unit (25). It shows how the motor-gyro is rotatably mounted to 19 including the retaining ring (35).

FIGS. 14 and 15 describe a third embodiment of the present invention, wherein (FIG. 14) the gyro unit (53) is comprised of a toroidal structure (54) containing either magnetic or electro-magneto-dynamic particles (52) by themselves or distributed within a medium and made to rotate in direction RP by the action of a rotating electromagnetic field produced by an applicable means (50) and (51). FIG. 15 illustrates how this embodiment can be constructed so that the gyro unit (53) can be rigidly fixed to a hub (H) without the need for a rotatable mounting.

FIG. 16 shows a preferred arrangement of the third embodiment of this invention. RP indicates the direction of rotation of the gyroscoping particles within the separate toroidal structures, rigidly fixed to H and rotated in direction R by motor F.

FIG. 17 is a perspective cross-section of the fourth embodiment of the present invention. Wherein two toroidal structures each capable of containing a magnetic or electro-magneto-dynamic fluid and able to induce said fluid to rotate in directions RF, within the structure (54) are connected via a conduit (61), having valves (60) which allow and restrict passage of said fluid when desired and a series of accelerators (62, 63, 64) to impel the fluid through the conduit in one direction and then in the other.

FIG. 18 shows the fourth embodiment incorporated into the third embodiment. Wherein gyro units leaving the conversion phase (CP) at TR2, transfer most of the gyroscopic mass, through the open accelerator conduit 61, to the opposite gyro unit entering CP at TRI.

FIG. 19 is a side view of the fifth embodiment of the present invention. It is comprised of two motor-gyro units (25 and 28) arranged opposite each other and each being rotatably mounted in main structure 19. The main structure is made to rotate by the action of motor 20 which itself is rigidly fixed to the vehicle 24.

### DETAILED DESCRIPTION OF THE INVENTION

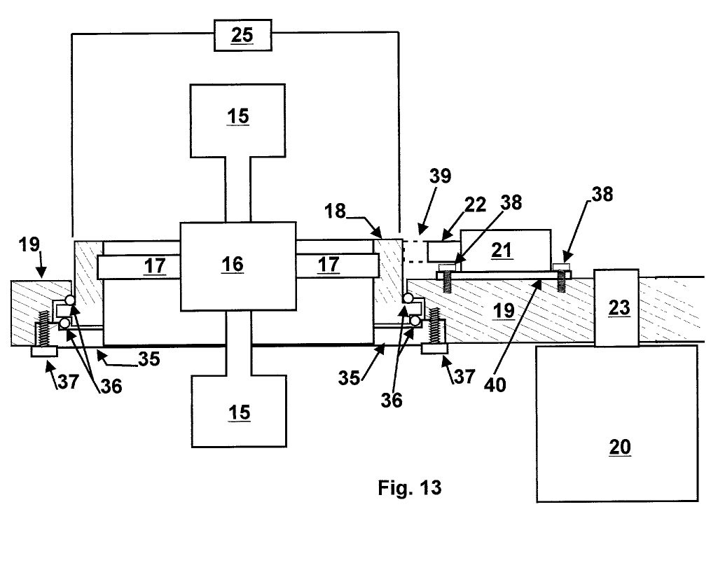

Referring now to FIG. 12, which is an isometric drawing of the first embodiment of the present invention wherein four identical gyroscopic units 25, 28, 29, 30, henceforth called motor-gyros, are equally spaced around a balanced, rotating main structure 19, and rotatably mounted to said main structure. The motor-gyro units consist of a mass 15, preferably designed to maximize the gyroscopic effects, a means to spin the mass 16, (in this case an electric motor), which is rigidly fixed via a cross member 17, to a support 18, that allows 360 degree rotation of the spin axis of the gyroscopic mass AB when mounted to the main structure 19 so that the rotation of spin axis AB is independent of the rotation of main structure 19 Also mounted to the main structure are a means, (in this case a solenoid 21) to lock the motor-gyro unit in place, so that axis AB does not rotate relative to 19 during the active part of the cycle and release it to a free spinning state during the inactive part of the cycle. Furthermore while the rotatable mount must allow free unlimited rotation of the gyro axis AB, it must also maintain the gyro's spin axis perpendicular to the spin axis of the main structure 23 at all times. FIG. 13 is a cross-section drawing that shows in detail how a preferred embodiment of the aforementioned rotatably mounted motor-gyro unit accomplishes this. The unit 25, is comprised of a motor 16, the gyro mass 15, and a supporting cross member 17 which is rigidly fixed to a rotatable mount 18. Bearings 36 allow unlimited rotation of the motor-gyro unit 25, while keeping the spin axis of the gyroscopic mass 15 perpendicular to the spin axis of the main structure 19 at all times. The motor-gyro unit is retained within the main structure 19 by a retainer ring plate 35, which itself is rigidly fixed by fasteners 37 to the main structure. A clamping device 21 (in this case a solenoid) is also rigidly fixed to 19 via a mounting plate 40 by fasteners 38. At a predetermined point in the operational cycle clamping device 21 is energized pushing clamp 22 into position 39 so as to couple unit 25 to the main structure 19. With 22 in position 39 it is clear to see that unit 25 is no longer free to rotate relative to 19. Referring to FIG. 12, the main structure 19, is made to uniformly rotate by a means 20 (in this case an electric motor), said means being rigidly fixed to 24 which may be understood to be a structure (such as an enclosure) that is rigidly mounted to the vehicle or may be the vehicle itself.

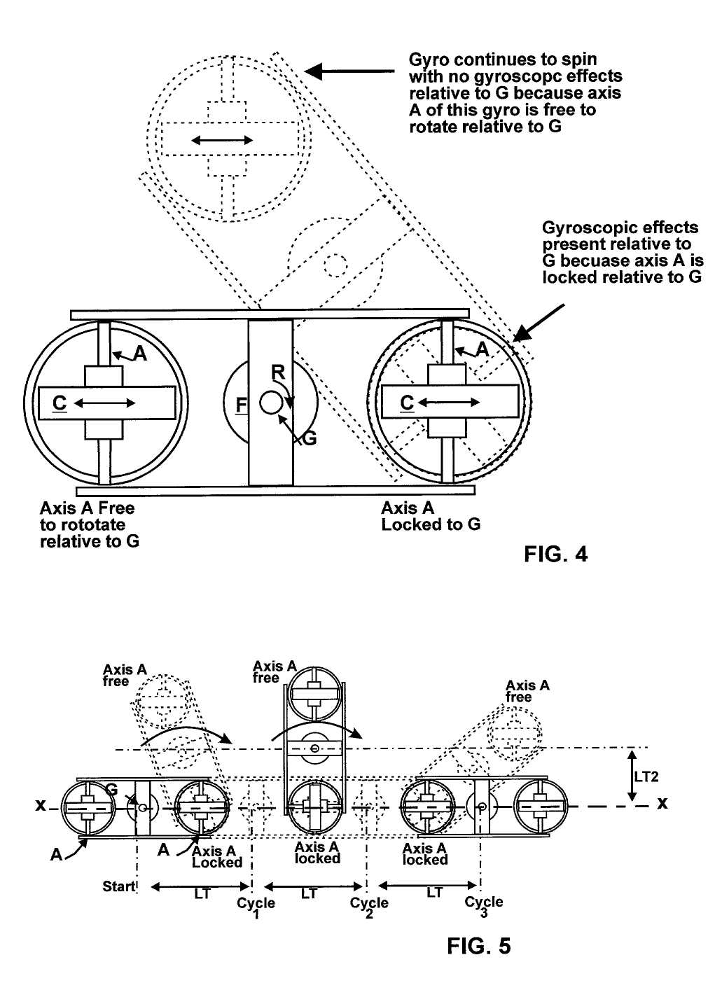

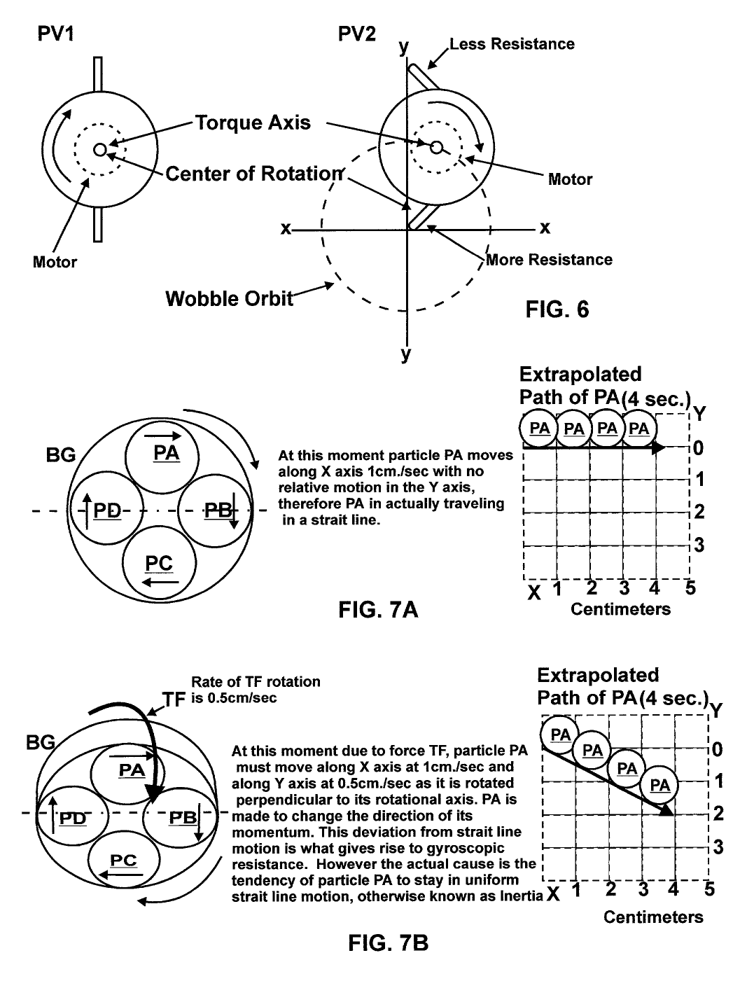

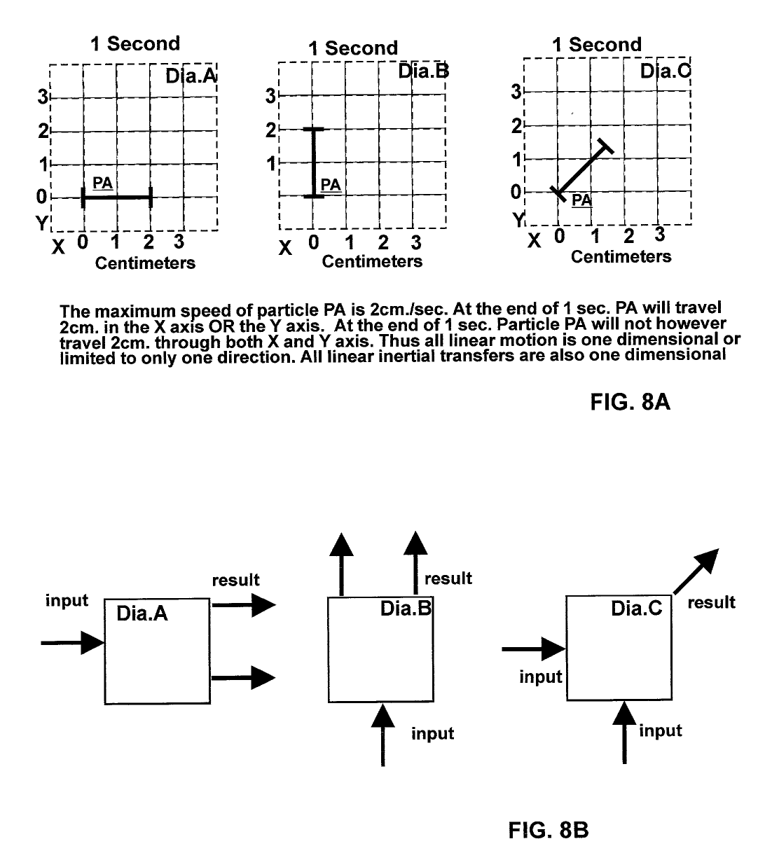

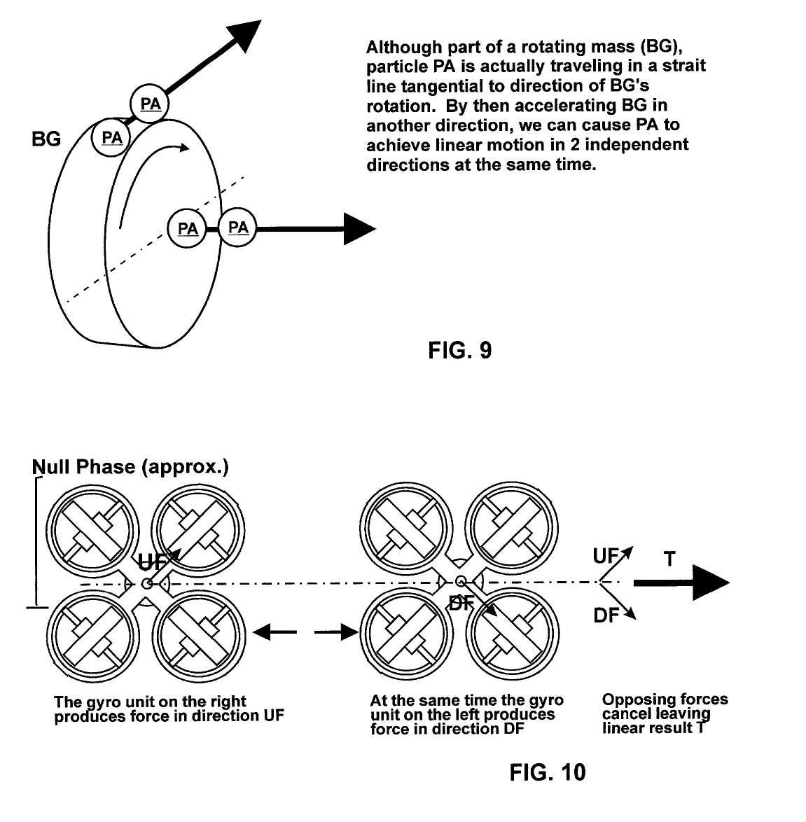

In operation, all four motor-gyro units are energized and the gyros are spun to the maximum speed allowed by the material comprising the gyroscopic mass. The direction of gyro mass spin is irrelevant as regards the direction of output thrust. The means of torque 20, rotates the main structure 19 in direction 26, via the output axle 23 which is also the center of rotation of 19. As each motor-gyro unit enters the Conversion Phase (CP) at point CP1, the coupling device 21 is energized, coupling the previously freely rotating unit to 19 so that the motor-gyro unit is now not free to rotate relative to 19. Since 19 is rotating due to the action of 20, the spin axis of the gyroscopic mass in the locked gyro is now being rotated through an angle equivalent to the degrees of arc of CP. Whereas the spin axis of gyroscopic masses in the Null Phase (the arc of rotation between points CP2 and CP1 that lies outside of CP) are free spinning, and remain rotationally unaffected. Therefore a rotational resistance is now present in only this part of the main structure. As illustrated in FIG. 6, where, in a sufficiently viscous medium, an imbalance of rotational resistance causes the torque axis of PV2 to follow a wobble orbit. This unbalanced resistance alters the center of rotation of the drive causing the torque axis of the drive to follow a wobble orbit, as illustrated in FIG. 4. The simplest embodiment of this invention as shown in FIG. 5 is propelled by cyclically alternating the state of the two motor-gyro units between locked and free spinning producing two linear motions, with the undesired motion LT2 rising from baseline to a maximum and returning to the baseline. The first embodiment illustrated in FIG. 12 produces thrust using the same basic behavior, however by the presence of more than one gyro unit in the Conversion Phase (CP), this design minimizes the unwanted LT2 linear component. As can be understood from FIG. 10, when two gyro units occupy the Conversion Phase, their secondary linear components, UF produced by the right unit and DF produced by the left unit, tend to cancel each other leaving T. Thus in FIG. 12 the resultant thrust is in direction 27 along the X axis of the main structure. As can be seen from FIG. 12 the direction of the resultant thrust is dependent on both the direction of main structure (19) rotation and the location of CP relative to the main structure. For instance if CP in FIG. 12 where rotated 180 degrees the resultant thrust would be reversed in the X axis. Likewise a 90 degree rotation of CP would result in thrust in the Y axis. Since the location of CP is determined by when the gyro units are locked in relation to 19, which is determined by the activation of the clamping device, the present invention can produce near instant thrust in any direction parallel the plane of rotation of the main structure. The amount of thrust produced can be altered using three separate methods. The simplest being the amount of torque applied by 20 to 19, an increase of torque yields an increase in thrust output, until the maximum thrust potential is reached. Thrust can also be modulated by altering the rate of spin of the gyroscopic means, an increase the spin rate of 15 causes an increase in the thrust output and an increase in maximum thrust potential. Thirdly changing the angle of CP will cause changes in output however this method also causes changes in overall efficiency and smoothness, a very narrow CP angle wil produce less output thrust but will increase efficiency and increase the amplitude of the unwanted linear motion. Using FIG. 12 as an example, if CP where a significantly narrower angle, the amount of thrust in the X axis would be reduced, while the efficiency would be increased, and motion in the Y axis would also increase in amplitude. It is important to point out that the beginning position of the gyroscopic mass is irrelevant to the operation of the drive. This is because gyroscopic resistance is produced from the attempt to rotate the gyro's spin axis in any direction that is perpendicular to said spin axis. The direction of spin of the gyroscopic mass 15 does not affect the thrust produced by the drive. No rotational speed relationships need be maintained other than maintaining a sufficiently high gyroscopic spin so as to produce significant gyroscopic resistance in 15.

As mentioned above the drive produces thrust, by causing an imbalance of rotational resistance. In a viscous medium, when a powered rotating object encounters uneven rotational resistance, the point of that resistance essentially becomes the center of rotation, this behavior conserves energy. The resistance basically displaces the amount of mass needed to ensure that there is no net energy loss. If the imbalance is small, the wobble orbit produced has a small circumference and little force. If the imbalance is large, the wobble orbit produced has a large circumference and significant force. As shown in FIG. 6, PV2 the wobble orbit induced gives the torque axis of the object components of linear motion. It is easy to see that the orbiting object oscillates an equal distance from the center of rotation in the Y and X axis, so that no net travel is achieved. Therefore it can be seen that while the object appears to gain motion, albeit orbital, it is really simply rotating around a resistance, that forces the objects center (and in this case its torque center) away from its rotational center. Thus the displaced mass does not cause any movement of the center of rotation, the new rotational center always remains at the center. If increasing mass is added to PV2 opposite to the resistance, the center of rotation will simply move closer to the objects torque center, if enough mass is added the center of rotation will once again coincide with the center of torque and all wobbling tendencies will cease.

In the present invention, the imbalance of resistance is caused by gyroscopic resistance to the reorientation of its spin axis. Thus a wobble orbit is induced in the manner outlined above. The various embodiments of the present invention produce linear motion by changing the position of the resistance to cause only half of the wobble orbit to develop. This fully extracts predominantly only one linear component of the wobble along 180 degrees of the orbit, and extracts half of the linear component at 90 degrees. The undesired 90 degree linear component is further minimized in embodiments one, two, three, and four, by the presence of multiple gyro units in the thrust producing portion of the cycle (the Conversion Phase) simultaneously.

The preceding only describes how the present invention uses various physical behaviors to achieve linear acceleration. To anyone skilled in the pertinent science, it is known that in order to gain or lose momentum, there must be an inertia/momentum exchange between two or more masses, Newton's Third Law describes this fact, however it will be shown that the Third Law does not accurately describe all inertial exchanges. Therefore before describing any other embodiments of the present invention, it must be made clear how momentum is exchanged in the operation of the present invention. The method of inertia/momentum exchange will be summarized below, a full explanation of the concepts employed can be found in the section of this specification entitled “Background of the Invention”.

Newton's Third Law “To every action there is an equal and opposite reaction” describes two separate components of inertia/momentum exchanges. “Equal” refers to the amount of energy of the exchange and “opposite” refers to the angle of the exchange which is 180 degrees. Rotating masses are an exception to this law. A rotating mass (gyroscope) can produce a 90 degree inertia exchange. The very obvious evidence of this potential is gyroscopic resistance to rotation of its spin axis. Inertia/momentum is exchanged when a force is applied to reorient the gyro's spin axis. As illustrated in FIG. 7B a force (TF) which is applied to a gyroscopic mass perpendicular to its spin axis causes the gyro to lose rotational or angular momentum. The direction of the inertia/momentum lost is at right angles to the direction where the resistance is felt. In other words TF encounters resistance when toppling BG, and the rotation of BG is slowed because moment to moment the atoms of BG are traveling in a strait line in the direction of spin of BG, the resistance felt by TF is actually the momentum of the atoms comprising BG in the direction of BG's spin. Thus the inertia/momentum exchange between TF and the rotating BG occurs at 90 degrees, and not 180 degrees as described by Newton. A further proof of this concept is that no force can cause a gyroscoping mass to gain momentum in rotating perpendicular to its spin axis. While this is not possible under Newton's 180 degree rule, using the 90 degree inertial exchange concept submitted by this inventor, it is easy to see that momentum cannot be gained because the gyros resistance to reorientation is actually the manifestation of pure inertial force which like magnetic force, has no mass and thus cannot gain momentum. Therefore in operation of the present invention the inertia/momentum exchange ultimately occurs between the vehicle and the gyroscopic masses comprising the invention.

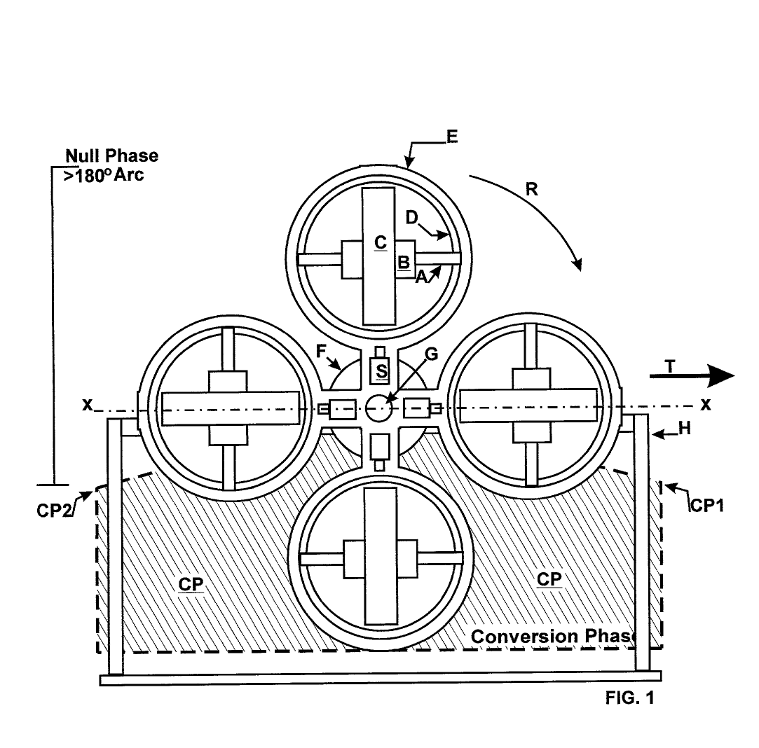

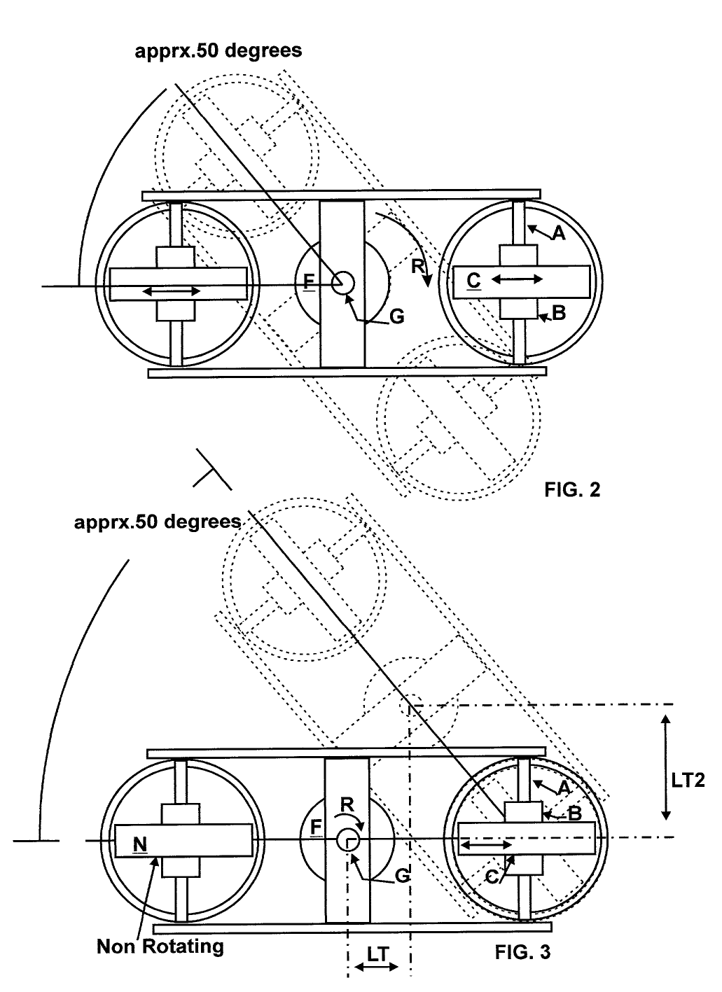

It will be clear now to those skilled in the art that the maximum motive force of the invention is directly related to the amount of angular momentum in the gyroscopic masses, and that the means used to rotate the main structure containing those gyroscopic units, essentially changes the direction of the momentum. Likewise altering the rate of the main structure 19 in FIG. 1, alters the amount of momentum extracted from the gyroscopic masses, and not the amount of momentum potential. Thus although there are three different ways to modulate the thrust output the only way to truly increase the thrust output potential is to apply more energy into spinning the gyroscopic masses.

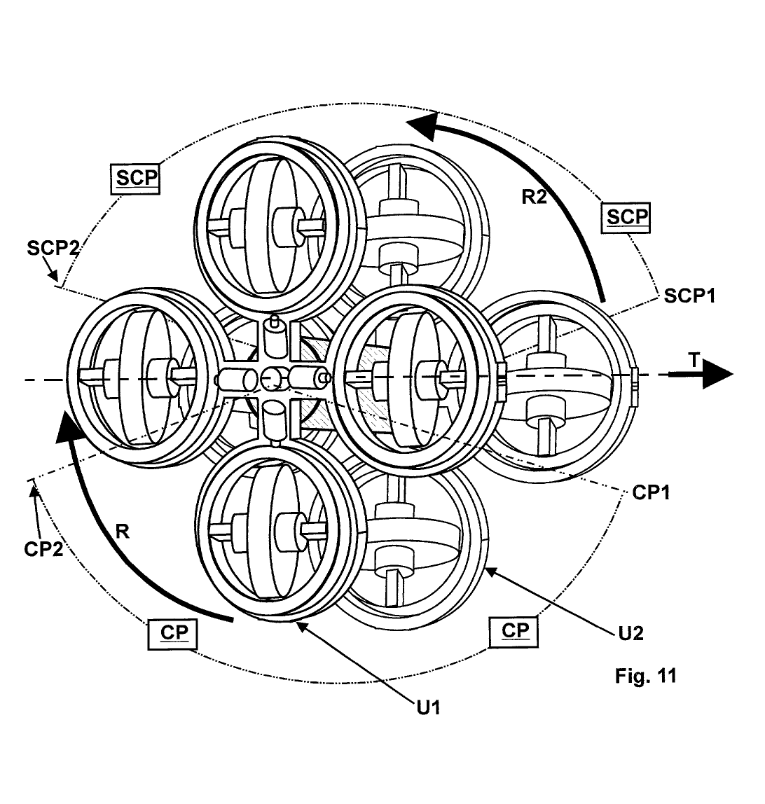

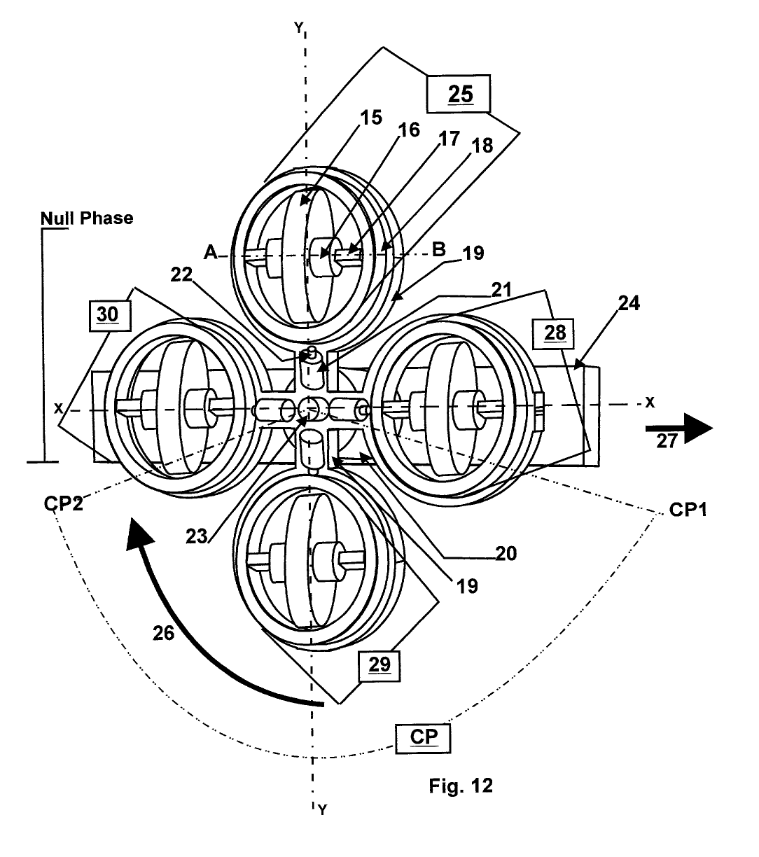

FIG. 11 illustrates the second embodiment of this invention, wherein two first embodiments are connected through a motor that rotates each in an opposite direction. The foreground part of this drive U1, rotates in direction R, its Conversion Phase (CP), begins at point CP1 and ends at point CP2, producing a resultant thrust in direction T. The background part of the drive U2, rotates in direction R2, its Conversion Phase (SCP), begins at point SCP1 and ends at point SCP2, producing a resultant thrust also in direction T. The improvement over the first embodiment is the nullification of counter-rotational forces produced by the powered rotation of the main structure.

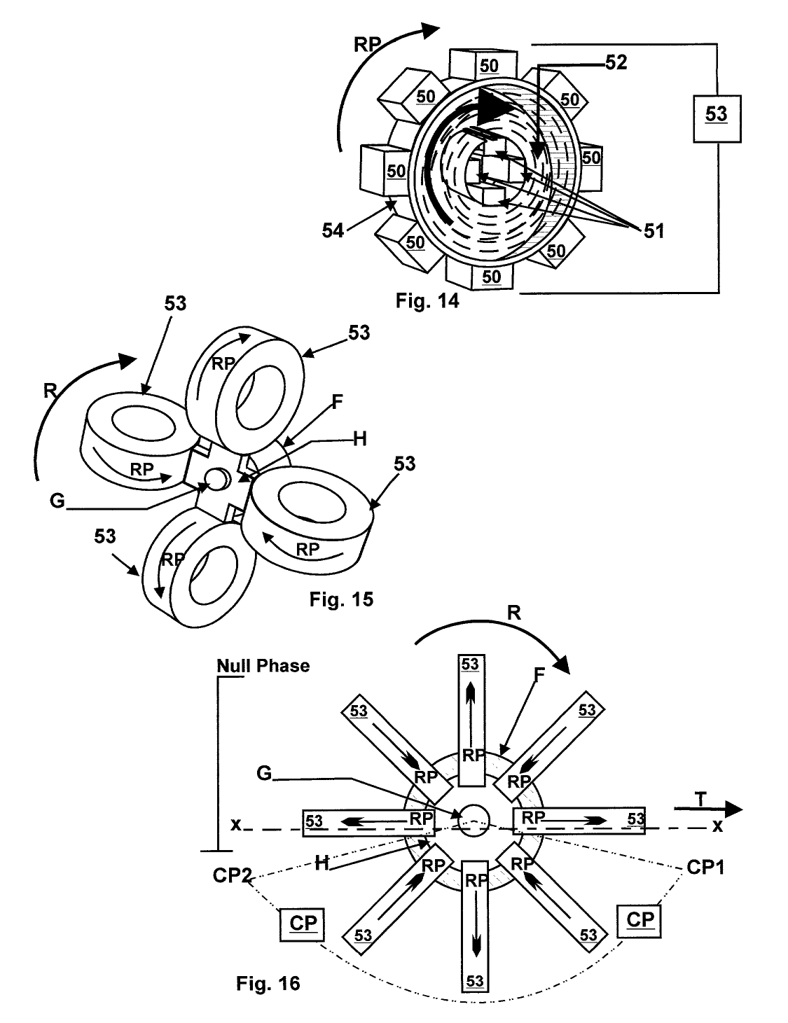

FIGS. 14 and 15 show a third embodiment of the present invention. FIG. 14 illustrates a purely magnetically driven gyro unit 53 in which the gyroscopic mass 52, is comprised of separate particles as opposed to a solid object. Enclosed within a toroidal shaped structure 54, are a given mass of magnetic or electro-magneto-dynamic particles. The term electro-magneto-dynamic is used to refer to compositions of matter whose molecules can be moved in a linear fashion by either electrostatic charges, magnetic fields, electrical fields/currents, or other electromagnetic phenomena. These particles can be of any size and may be suspended in a carrier fluid or may be contained within 54 with no carrier. 50 and 51 are accelerator units able to move the particles comprising the gyroscopic mass. For simplicity 52 can be considered to be magnetic particles and accelerators 50 and 51 can be considered to be electromagnets. Additionally accelerator units can be placed at any point around the torus or inside the torus to either motivate the particles or as a containment for said particles. In operation 50 and 51 cause a magnetic field that rotates in direction RP. The particles of the gyro mass 52, are thus made to spin in the indicated direction within 54, thus 52 becomes a gyroscope. This offers the advantage of very fast spin up of the gyroscopic mass when compared to the first and second embodiments, due to the fact that the magnetic field can apply force to nearly all of the particles comprising the gyroscopic mass at the same time, whereas force can be applied to a solid mass only at a given point. FIG. 15 shows a simplified application of this in the third embodiment of the present invention. Multiple gyro units 53, are uniformly arranged around and rigidly fixed to a main structure H. The main structure is made to rotate in direction R by the action of motor F through axle G. The direction of spin of the gyroscopic mass within each unit is indicated by RP. Due to the benefit of fast spin up times a rotatable mount for the gyro units is not needed.

FIG. 16 is a top down view of the third embodiment illustrates the operation of the third embodiment. The gyroscopic masses within the gyro units 53, rotate in direction RP within the unit when the gyro unit is energized. All gyro units 53, are rigidly fixed to a hub H, and although simplified in this drawing many more gyro units of varying size can be arranged and fixed to H so that much of the space between units can be filled with gyroscopic mass. Motor F rotates H through axle G in direction R. The gyro units 53, are energized to spin the gyroscopic mass only when in the Conversion Phase CP. Gyro units are energized at point CP1 and de-energized at point CP2. So that during the Null Phase, which is between points CP2 and CP1 outside arc CP, virtually no gyroscopic effects are present. Thus the resultant thrust is in direction T. The main operational concepts and behaviors of the third embodiment illustrated in FIG. 16 are the same as those in the first and second embodiments as regards cancellation of the unwanted 90 degree oscillations, connecting two third embodiment through a motor that rotates each opposite to the other in order to cancel counter-rotational forces and the other basic operational concepts. The major difference is that directional changes though still possible in any direction parallel to the rotational plane of the main structure, are no longer instantaneous, since the gyro unit must spin the gyroscopic mass from a resting state before any momentum can be extracted. The major advantages are that many more gyro units can be made to be within CP at one time since the gyroscopic unit does not rotate relative to the main structure. So the power to weight potential is much higher in the third embodiment. It is also less mechanical and thus more reliable. Very high spin rates are possible due to the absence of bearings. Although not critical to the design if sufficient containment forces are applied, friction can be nearly eliminated further increasing efficiency and reliability.

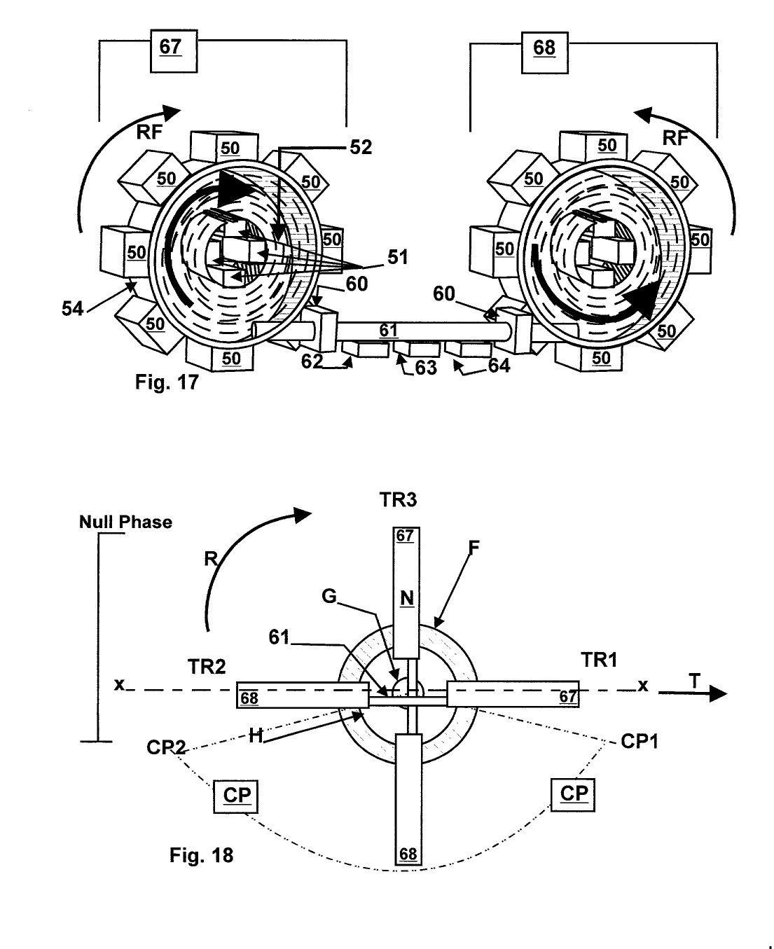

The fourth embodiment is illustrated in FIG. 17. In this embodiment the basic concept is identical to the third embodiment in the design and function of the gyro units, with the exception that the gyroscopic mass 52, is an electro-magneto-dynamic fluid or a homogeneous suspension of electro-magneto-dynamic particles, such that said suspension behaves as a fluid. Another difference is that opposing gyro units 67 and 68 are connected by a conduit 61, able to convey the gyro mass in both directions from one gyro unit to the other. In operation the paired gyro units 67 and 68 share most of the gyroscopic mass 52 and are designed to rotate the fluid mass in opposite directions in relation to each other RF, when each gyro unit is located in the Conversion Phase and contains the gyro fluid. Devices 50 and 51 impel the gyroscopic mass around the inside of the toroidal structure 54 for part of the cycle. At a predetermined point valves 60 are opened to allow the gyroscopic fluid passage through the conduit 61. The fluid is impelled through conduit 61 by the action of accelerators 62, 63, and 64. When the predetermined amount of fluid mass has been transferred valves 60 are closed and the gyroscopic fluid in the second gyro is rotated so as to develop gyroscopic effects.

FIG. 18, a simplified top down illustration of the fourth embodiment of the present invention. In operation paired units 67 and 68 are rigidly fixed to main structure H. Motor F rotates H in direction R through axle G. At point TR1 the gyroscopic fluid is accelerated through conduit 61 from the gyro unit entering the Null Phase at TR2 to the opposite gyro unit, entering CP (Conversion Phase). Therefore the gyro unit in CP contains nearly all of the gyro mass shared between gyro pair and the gyro the Null Phase at point TR3 contains almost no gyroscopic mass. The behaviors and concepts governing the production of thrust in this the fourth embodiment are identical to those of the third embodiment. This fourth embodiment benefits from all the advantages of the third embodiment and provides two additional benefits. The primary improvement being a higher power to weight ratio. Since during the Null Phase, the degree of arc between CP2 and CP1 outside the Conversion Phase (CP), no useful work is done by the gyroscopic mass at all, this embodiment transfers the gyroscopic mass to CP. Therefore the fourth embodiment is able to produce thrust using approximately half the mass of any other embodiment of the present invention. This embodiment also benefits from the centrifugal overbalanced caused by the extra mass located in one area of the main structure. This centrifugal overbalance serves to increase the thrust produced in direction T.

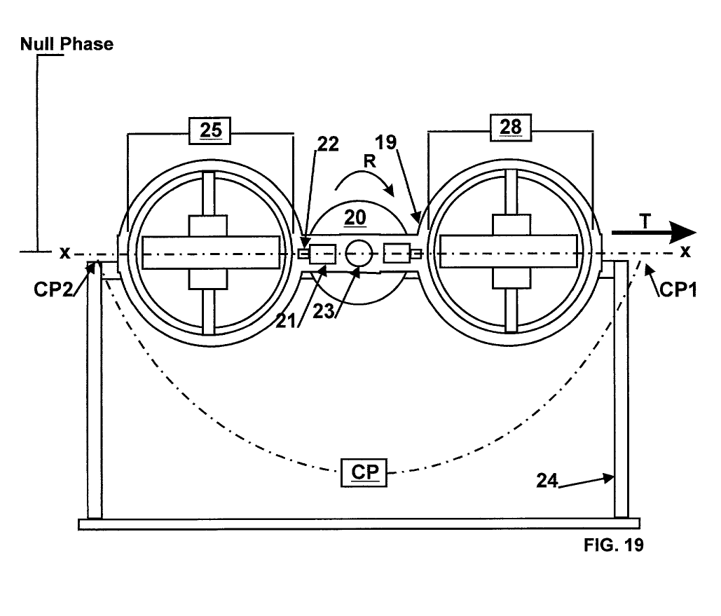

FIG. 19 is a side view of the fifth embodiment of this invention. This is the simplest embodiment of the present invention that is capable of continuous linear translation. Two motor-gyro units 25 and 28 are arranged opposite each other and rotatably mounted in a structure 19. The motor-gyro units are the same as described in FIG. 13. Main structure 19 is made to rotate in direction R, by the action of motor 20 via axle 23 to which 19 is rigidly fixed. Means of torque 20 is rigidly fixed to 24, which may be understood to be a vehicle or to be an enclosure rigidly fixed to a vehicle. Also rigidly fixed to 19 is clamping device 21, which at a predetermined point is used to hold the gyro unit motionless relative to 19. In operation the arc of Conversion Phase (CP) and the Null Phase are both 180 degrees. Thus as 28 is entering CP at point CP1, 21 is energized and clamp 22 engages gyro unit 28 in order to couple it to 19 preventing rotation of 28 relative to 19. At the same moment the opposing gyro unit 25 at point CP2, is made to freely rotate relative to 19 by the release of the clamping device. Thus an imbalance of rotational resistance is produced which causes the center of torque located at 23, to follow a wobble orbit. Referring now to FIG. 5, due to the absence of mitigating forces, this embodiment transmits both LT and LT2 linear components of the wobble orbit produced. FIG. 5 shows the leapfrog like quality of the linear thrust produced in the X axis in direction T. In addition because the direction of motion is predominantly in Y axis ( i.e. LT2) at 0 degrees and again at 180 degrees, while the direction of motion is predominantly in the X axis (i.e. LT) at 90 degrees, this embodiment produces a pulsing thrust that increases in force then decreases. Even if two fifth embodiments are connected through a motor and made to counter-rotate, some or all of the LT2 linear component may be canceled but the pulsing quality of the thrust would remain. The principal advantages of this embodiment is simplicity of construction and a higher overall efficiency than embodiments that dampen the LT2 linear component within the single drive unit itself.

The electromagnetic form of motor-gyros shown in this specification are simply illustrative of the kind constructed for the prototype, any kind of gyro can be used. Likewise the means of rotating the main structure in all embodiments described is based on electrical motors, however any type of engine or motor capable of applying torque to the main structure, can be used to produce thrust from the present invention. Even a reciprocating rotary motion can be made to provide unidirectional thrust, provided the Conversion Phase is properly positioned and synchronous with the rotary stroke. Similarly the rotatable mount illustrated is only one way to mount a gyroscopic mass in a way that allows 360 degree rotation. A person skilled in the art may devise alternative methods for accomplishing the same. Variations of the above described invention can achieve similar or improved results over the embodiments described. For example using a gyroscopic mass comprised of a metal like aluminum which is capable of hysteresis and accelerating the gyroscopic mass directly using a rotating electromagnetic field, which will allow more power to be applied to the mass to impel it to rotate. For simplicity the first, third, fourth, and fifth embodiments have been presented in their most elemental form of the drive with no consideration to the counter-rotational forces that will be transmitted to the attached vehicle by their activation. As demonstrated in the second embodiment, all of the other embodiments of the present invention can be paired with a twin drive unit whose main structure or hub is torqued in the reverse direction which cancels all counter-rotational forces while producing thrust in a single unified direction. The intended primary application of the present invention is in the propulsion of spacecraft. A secondary application as flight control assist devices for aircraft can also be envisioned.

Although the descriptions above contain many specifics, these should not be construed as limiting the scope of the present invention but as merely providing illustrations of the presently preferred embodiments. A person understanding this invention may now conceive of alternative structures, compositions of matter, embodiments or variations of the above. It is intended to encompass all such changes and modifications as fall within the scope and spirit of the claims appended hereto and thereby considered to be part of the present invention.

What I claim as my invention is:

1. A method for producing a propulsive force in a primary and secondary direction exploiting the effect of gyroscopic resistance, said method comprising the steps of:
connecting at least two gyroscopic means to a rotatable structure wherein the gyroscopic effect axis of the gyroscopic means is perpendicular to the rotational axis of said rotatable structure,
causing said rotatable structure to be rotated so that the gyroscopic means are made to travel degrees of arc around the rotational axis of the rotatable structure,
causing said gyroscopic means to exhibit gyroscopic resistance,
causing said gyroscopic means to follow a path so as to produce gyroscopic resistance to the rotation of said rotatable structure during said path around the rotation axis of the rotatable structure,
causing one gyroscopic means, to exhibit greater gyroscopic resistance during part of the arc around the rotatable structure while said rotatable structure is rotated, whereby the gyroscopic resistance of the gyroscopic means causes said gyroscopic means to become the center of rotation of said rotatable structure, during a number of degrees of arc, after which a different gyroscopic means, connected to said rotatable structure, is made to exhibit greater resistance so that a second gyroscopic means becomes the center of rotation for said rotatable structure,
causing said gyroscopic means to exhibit gyroscopic resistance in an alternating cycle in such a way as to cause the center of rotation of said rotatable structure to be relocated in a predetermined path, whereby a primary and a secondary motion is produced in said rotatable structure, in which the primary motion is linear and in a predetermined direction and the secondary motion is reciprocating and at right angles to said primary motion.

2. A method according to claim 1 wherein a plurality of gyroscopic means are connected to a rotatable structure in a way so that when said rotatable structure is rotated multiple gyroscopic means are made to exhibit a greater gyroscopic resistance during a predetermined number of degrees of arc around the rotational axis of said rotatable structure, so that the center of rotation of said rotatable structure is relocated in a continuous sequence wherein the secondary motion which is at right angles to the primary motion is significantly reduced, while the force of the primary linear motion is enhanced.

3. A method according to claim 1 or 2 wherein the gyroscopic means is rigidly fixed to a platform that is rotatably mounted to said rotatable structure and includes a means by which to couple and de-couple said platform relative to said rotatable structure so that said platform can freely rotate in relation to said rotatable structure for a predetermined degree of arc around said rotatable structure when de-coupled and unable to rotate relative to said rotatable structure when coupled, so that said gyroscopic means although continuously energized can exhibit gyroscopic resistance for predetermined degrees of arc and then not exhibit gyroscopic resistance for predetermined degrees of arc.

4. A method according to claim 1 or 2 wherein the gyroscopic means is comprised of a container wherein resides a composition of matter whose molecules can be moved in a linear fashion by electrical or magnetic phenomena, whereby when energized said composition of matter becomes a gyroscopic mass able to exhibit gyroscopic resistance.

5. A method according to claim 1, 2 or 4 wherein the gyroscopic means is made to exhibit gyroscopic resistance by energizing said means during a number of degree of arc around said rotatable structure, whereas gyroscopic resistance is not exhibited during a number of degree of arc around said rotatable structure by not energizing said gyroscopic means.

6. A method according to claim 1,2,3 or 4 wherein two or more rotatable structures containing gyroscopic means are rotated in opposite directions relative to each other in such a way as to eliminate counter-rotational forces and said gyroscopic means are arranged in such a way as to eliminate precessional moments in the system.

7. An apparatus for producing a propulsive force in a primary and secondary direction exploiting the effect of gyroscopic resistance, said apparatus comprised of:
at least two gyroscopic means mounted to a rotatable structure, wherein the rotational axis of said gyroscopic means is perpendicular to the rotational axis of said rotatable structure,
a means to rotate said rotatable structure
a means to cause said gyroscopic means to exhibit gyroscopic resistance for a predetermined degree of arc around the rotatable structure and then extinguish gyroscopic resistance in said gyroscopic means in a cyclical manner,
a means to minimize counter-rotational forces generated by rotating said rotatable structure

8. An apparatus according to claim 7 wherein the gyroscopic means is rotatably mounted to said rotatable structure, so that said gyroscopic means can freely rotate relative to said rotatable structure, wherein the spin axis of said gyroscopic means is maintained perpendicular to the spin axis of said rotatable structure.

9. An apparatus according to claim 7 wherein the gyroscopic means is a torus containing a composition of matter whose molecules can be moved in a linear fashion by electrical or magnetic phenomena and a linear accelerator or other motor capable of moving said composition of matter around said torus so that when energized the unit exhibits gyroscopic resistance.

10. An apparatus according to claim 7 or 9 wherein the gyroscopic means is a pair of toruses containing a composition of matter whose molecules can be moved in a linear fashion by electrical or magnetic phenomena and a motor capable of accelerating said composition of matter around said torus, arranged around said rotatable structure with a first torus unit connected to an opposing torus unit via a valved conduit wherein said composition of matter can be moved into, out of or retained within either torus as needed, so that during a predetermined degree of arc around said rotatable structure said composition of matter can be moved into one torus unit and energized so as to exhibit gyroscopic resistance and then emptied extinguishing gyroscopic resistance in a first torus unit, while said opposing torus is filled and said composition of matter energized so as to exhibit gyroscopic resistance in said opposing torus unit.

11. An apparatus according to claims 7, 8, 9, or 10 wherein a plurality of gyroscopic means are mounted to said rotatable structure, wherein two or more gyroscopic means are made to exhibit gyroscopic resistance to the rotation of said rotatable structure during a predetermined degree of arc around said rotatable structure so as to reduce the secondary right angle motion while enhancing the primary linear motion.

12. An apparatus according to claim 7 wherein the means to rotate said rotatable structure is an electric motor, linear drive or heat engine.

13. An apparatus according to claim 7 or 8 wherein the means to cause said gyroscopic means to exhibit gyroscopic resistance and then not exhibit gyroscopic resistance is a locking device that can couple and de-couple said rotatably mounted gyroscopic means to said rotatable structure, so that when coupled said gyroscopic means is not free to rotate relative to said rotatable structure whereas when de-coupled said gyroscopic means can freely rotate relative to said rotatable structure.

14. An apparatus according to claim 7, 8, or 9 wherein the means to cause said gyroscopic means to exhibit gyroscopic resistance and then not exhibit gyroscopic resistance is accomplished by energizing the gyroscopic means and de-energizing said gyroscopic means.

15. An apparatus according to claim 10 wherein the means to cause said gyroscopic means to exhibit gyroscopic resistance and then not exhibit gyroscopic resistance is a valved conduit wherein said composition of matter can be moved out of a first torus unit, extinguishing gyroscopic resistance, and into an opposing torus unit, wherein gyroscopic resistance is exhibited when energized.

16. An apparatus according to claim 7 or 11 wherein two or more rotatable structures share a common axle and are rotated in opposite directions relative to each other, whereby all counter-rotational forces produced by torque applied to said rotatable structure is canceled.
